(19) United States
(12) Patent Application Publication
(10) Pub. No.: US 2024/0347997 A1
(43) Pub. Date: Oct. 17, 2024

(54) MASTER OSCILLATOR POWER AMPLIFIER WITH SEEDED OSCILLATOR FOR FIBER LASER

(71) Applicant: Lumentum Operations LLC, San Jose, CA (US)

(72) Inventors: Ning LIU, Morgan Hill, CA (US); Guan SUN, San Jose, CA (US); Matthew KUTSURIS, Dublin, CA (US); Gongwen ZHU, San Jose, CA (US)

(21) Appl. No.: 18/330,656

(22) Filed: Jun. 7, 2023

Related U.S. Application Data
(60) Provisional application No. 63/495,854, filed on Apr. 13, 2023.

(51) Int. Cl. H01S 3/067; H01S 3/094; H01S 3/16; H01S 3/23

(52) U.S. Cl. CPC H01S 3/06733; H01S 3/0675; H01S 3/094007; H01S 3/1603; H01S 3/2308

(57) ABSTRACT

A master oscillator power amplifier system includes a seed laser oscillator and a master laser oscillator. The seed laser oscillator includes a first oscillator fiber with a first laser cavity configured to convert a first pump light into a first seed laser light in a fundamental mode as the first pump light interacts with a fiber core of the first oscillator fiber. The master laser oscillator includes a second oscillator fiber with second laser cavity configured to receive and convert the first seed laser light into a second seed laser light in the fundamental mode as the first seed laser light interacts with a fiber core of the second oscillator fiber, and receive and convert a second pump light into a primary laser light in the fundamental mode as the second pump light interacts with the fiber core of the second oscillator fiber.

### CROSS-REFERENCE TO RELATED APPLICATION

This Patent Application claims priority to U.S. Patent Application No. 63/495,854, filed on Apr. 13, 2023. The disclosure of the prior Application is considered part of and is incorporated by reference into this Patent Application.

### TECHNICAL FIELD

The present disclosure relates generally to master oscillator power amplifiers (MOPAs) and to MOPA systems with a seeded oscillator.

### BACKGROUND

High-power fiber lasers typically use cladding light-pumping technology. In a high-power fiber, active fibers are optical fibers that are doped with rare-earth elements (e.g., erbium, ytterbium, or thulium) inside a fiber core. In a cladding-pumped high-power fiber, pump light travels inside a fiber cladding of the fiber and laser light travels inside a fiber core of the fiber. The fiber core is almost uniformly illuminated by the pump light that travels inside a fiber cladding. The rare-earth element dopants inside the fiber core perform a stimulated emission by transforming the pump light into the laser light. As a result, the laser light is generated and/or amplified within the fiber core based on the pump light.

### SUMMARY

In some implementations, a MOPA system includes a seed pump comprising: a first plurality of laser sources configured to provide first source light; a first pump combiner configured to combine the first source light into a first pump light; and a seed laser oscillator comprising: a first oscillator fiber comprising a first fiber core and a first cladding surrounding the first fiber core; a first fiber Bragg grating (FBG) that is configured to operate as a first reflector at an input of the first fiber core; and a second FBG that is configured to operate as a first output coupler (OC) at an output of the first fiber core, wherein the first FBG and the second FBG define a first laser cavity of the first oscillator fiber, wherein the first pump combiner is configured to couple the first pump light into the first cladding, wherein the first cladding is configured to guide the first pump light, wherein the first fiber core within the first laser cavity is configured to convert the first pump light into a first seed laser light in a fundamental mode as the first pump light interacts with the first fiber core, and wherein the first fiber core is configured to guide the first seed laser light and output the first seed laser light at the output of the first fiber core; a pump signal combiner comprising: an input fiber comprising a second fiber core and a second cladding surrounding the second fiber core, wherein the second fiber core is coupled to the output of the first fiber core, and wherein the second fiber core is configured to receive and guide the first seed laser light in the fundamental mode; a second plurality of laser sources configured to provide second source light; a second pump combiner configured to combine the second source light into a second pump light; and an output fiber comprising a third fiber core and a third cladding surrounding the third fiber core, wherein the second pump combiner is configured to couple the second pump light into the third cladding, wherein the third cladding is configured to guide the second pump light, and wherein the third fiber core is configured to receive and guide the first seed laser light in the fundamental mode; a laser oscillator comprising: a second oscillator fiber comprising a fourth fiber core and a fourth cladding surrounding the fourth fiber core; a third FBG that is configured to operate as a second reflector at an input of the fourth fiber core; and a fourth FBG that is configured to operate as a second OC at an output of the fourth fiber core, wherein the third FBG and the fourth FBG define a second laser cavity of the second oscillator fiber, wherein the output fiber is configured to couple the second pump light into the fourth cladding, wherein the fourth cladding is configured to guide the second pump light, wherein the fourth fiber core within the second laser cavity is configured to receive the first seed laser light from the third fiber core and convert the first seed laser light into a second seed laser light in the fundamental mode as the first seed laser light interacts with the fourth fiber core within the second laser cavity, wherein the fourth fiber core within the second laser cavity is configured to convert the second pump light into a primary laser light in the fundamental mode as the second pump light interacts with the fourth fiber core due to a presence of the second seed laser light in the fundamental mode in the fourth fiber core, and wherein the fourth fiber core is configured to guide the primary laser light in the fundamental mode and the second seed laser light and output the primary laser light in the fundamental mode and the second seed laser light at the output of the fourth fiber core; and a power amplifier fiber coupled to the output of the fourth fiber core and configured to amplify the primary laser light in the fundamental mode and the second seed laser light.

In some implementations, a MOPA system includes a seed laser oscillator comprising a first laser cavity configured to receive a first pump light and convert the first pump light into a first seed laser light in a fundamental mode as the first pump light interacts with a first fiber core of the seed laser oscillator, wherein the first fiber core is configured to guide the first seed laser light and output the seed laser light at an output of the first fiber core; a pump signal combiner comprising: an input fiber comprising a second fiber core and an input fiber cladding surrounding the second fiber core, wherein the second fiber core is configured to receive and guide the first seed laser light in the fundamental mode; and an output fiber comprising a third fiber core and an output fiber cladding surrounding the third fiber core, wherein the output fiber is configured to receive a second pump light, wherein the second pump light is coupled into the output fiber cladding, wherein the output fiber cladding is configured to guide the second pump light, and wherein the third fiber core is configured to receive and guide the first seed laser light in the fundamental mode; and a primary laser oscillator comprising: an oscillator fiber comprising a fourth fiber core, an oscillator fiber cladding surrounding the fourth fiber core, and a second laser cavity, wherein the output fiber is configured to couple the second pump light into the oscillator fiber cladding, wherein the oscillator fiber cladding is configured to guide the second pump light, wherein the fourth fiber core within the second laser cavity is configured to receive the first seed laser light from the third fiber core and convert the first seed laser light into a second seed laser light in the fundamental mode as the first seed laser light interacts with the fourth fiber core, wherein the fourth fiber core within the second laser cavity is configured to convert the second pump light into a primary laser light in the fundamental mode as the second pump light interacts with the fourth fiber core due to a presence of the second seed laser light in the fundamental mode in the fourth fiber core, and wherein the fourth fiber core is configured to guide the second seed laser light and the primary laser light and output the second seed laser light and the primary laser light at an output of the fourth fiber core.

In some implementations, a method of generating primary laser light in a fundamental mode includes converting a first pump light into a first seed laser light in the fundamental mode as the first pump light interacts with a first fiber core within a first laser cavity of a seed laser oscillator; guiding the first seed laser light in the fundamental mode through a second fiber core of an input fiber of a pump signal combiner that is configured to receive the first seed laser light in the fundamental mode from the first fiber core; coupling second pump light into an output fiber cladding of an output fiber of the pump signal combiner that is configured to guide the second pump light; guiding the first seed laser light in the fundamental mode through a third fiber core of the output fiber that is configured to receive the first seed laser light in the fundamental mode from the second fiber core; coupling the second pump light from the output fiber into an oscillator fiber cladding of an oscillator fiber; coupling the first seed laser light in the fundamental mode from the output fiber into a fourth fiber core of the oscillator fiber; converting the first seed laser light into a second seed laser light in the fundamental mode as the first seed laser light interacts with the fourth fiber core within a second laser cavity of the oscillator fiber; converting the second pump light into the primary laser light in the fundamental mode as the second pump light interacts with the fourth fiber core within a second laser cavity of the oscillator fiber due to a presence of the second seed laser light in the fundamental mode in the fourth fiber core; and outputting the second seed laser light and the primary laser light at an output of the fourth fiber core.

### BRIEF DESCRIPTION OF THE DRAWINGS

FIG. 1 shows a MOPA system according to one or more implementation.

FIG. 2A shows a first oscillator fiber of a seed laser oscillator within a first laser cavity according to one or more implementations.

FIG. 2B shows a second oscillator fiber of a master laser oscillator within a second laser cavity according to one or more implementations.

FIG. 2C shows the second oscillator fiber of the master laser oscillator within the second laser cavity according to one or more implementations.

FIG. 3 shows a timing diagram for pump light turn on according to one or more implementations.

FIG. 4 shows a diagram illustrating different laser modes, including a fundamental mode.

FIGS. 5A-5D show various diagrams related to a laser output beam quality of a master laser oscillator according to one or more implementations.

FIG. 6 is a flowchart of an example process associated with a MOPA amplifier with a seeded oscillator for fiber laser generation.

### DETAILED DESCRIPTION

The following detailed description of example implementations refers to the accompanying drawings. The same reference numbers in different drawings may identify the same or similar elements.

A high-power fiber laser may include a pump combiner or a pump signal combiner, a master oscillator, and an amplifier, referred to as a master oscillator power amplifier (MOPA). The pump combiner (or pump signal combiner) combines laser light from multiple pump laser diodes into a fiber cladding of an output fiber. Additionally, the pump signal combiner has an input fiber. When input signal light is launched into a fiber core of the input fiber, the input signal light has little loss while passing through the pump signal combiner to the fiber core of the output fiber. The input signal light may have a wavelength such that the input signal light passes through the master oscillator and the amplifier to a laser output.

The master oscillator is configured to generate laser light at a wavelength λ_{Laser} by a laser cavity which is formed by a reflector FBG (e.g., a high reflector (HR) FBG) and an OC FBG. The amplifier receives laser light that has been generated and output by the master oscillator and amplifies the laser light to a higher power.

A laser mode inside a fiber core is related to a fiber core size of the fiber core. There will be higher-order transverse modes (i.e., higher-order modes) inside a fiber core with a larger fiber core size, referred to as a multimode fiber. For example, a single-mode fiber has a single-mode fiber core that has a diameter (e.g., a fundamental mode diameter) that supports light only in a fundamental mode. In contrast, the multimode fiber has a multimode fiber core with a diameter (e.g., a multimode diameter) that is sufficiently large to support multiple modes of light. With a continuing increase of output power in high-power fiber lasers, nonlinear effects (e.g., stimulated Raman scattering (SRS)) in the fiber will cause detrimental effects on the high-power fiber laser, such as laser instability, lower efficiency, and additional heating resulting in higher temperatures. In order to reduce the generation of the nonlinear effects, a core size of the fiber core may be increased so that optical power densities inside the fiber core are reduced. However, increasing the fiber core size may cause the laser to not operate at the fundamental mode, and instead operate at higher-order transverse modes. Operating at higher-order transverse modes results in a degradation on the laser output beam quality, caused by higher-order transverse modes in the fiber. This results in a poor laser beam focus point. Accordingly, a tradeoff exists between a reduction of fiber nonlinear effects by increasing the core size and a degradation of laser output beam quality caused by increasing the core size.

Some implementations provide a master oscillator power amplifier (MOPA) system that includes a seed laser oscillator and a master laser oscillator. The seed laser oscillator includes a first oscillator fiber with a first laser cavity configured to receive a first pump light and convert the first pump light into a first seed laser light in the fundamental mode as the first pump light interacts with a fiber core of the first oscillator fiber. The master laser oscillator includes a second oscillator fiber with second laser cavity configured to receive a second pump light and the first seed laser light in the fundamental mode, convert the first seed laser light into a second seed laser light in the fundamental mode as the first seed laser light interacts with a fiber core of the second oscillator fiber, convert the second pump light into a primary laser light in the fundamental mode as the second pump light interacts with the fiber core of the second oscillator fiber due to a presence of the second seed laser light in the fundamental mode in the fiber core of the second oscillator fiber, and output the primary laser light in the fundamental mode and the second seed laser light in the fundamental mode. In some implementations, the master laser oscillator may be configured to output the primary laser light in the fundamental mode and the second seed laser light in the fundamental mode as combined laser light.

Accordingly, the master laser oscillator may generate both the second seed laser light in the fundamental mode and the primary laser light, which is substantially in the fundamental mode. Due to the presence of the second seed laser light in the fundamental mode in the second laser cavity of the master laser oscillator, the combined laser light in the master laser oscillator has more light (e.g., a higher quantity or density of light) in the fundamental mode and less light (e.g., a lower quantity or density of light) in higher modes. The combined laser light generated by the master laser oscillator, having mostly light in the fundamental mode, may be coupled into an amplifier to be amplified. Since a higher quantity of laser light in the fundamental mode is received by the amplifier, amplified light output by the amplifier also has a higher quantity of laser light in the fundamental mode. Thus, the laser output beam quality at the output of the master laser oscillator and at the output of the amplifier may be improved.

For example, nonlinear effects can be reduced at the output of the master laser oscillator. Furthermore, the seed laser oscillator allows the core size of fiber of the master laser oscillator to be increased, which will reduce the generation of nonlinear effects, while at the same time maintain a laser output (e.g., the combined laser light) of the master laser oscillator mostly in the fundamental mode. Thus, the laser output beam quality can be maintained or improved, despite the core size of fiber of the master laser oscillator being increased. Additionally, the seed laser oscillator may enable the MOPA system to produce high-power fiber lasers that have fewer higher-order transverse modes, even with larger core-sized fiber, due to the output light from the master laser oscillator being mostly or substantially in the fundamental mode. This may help to maintain the laser output beam quality and to prevent the laser output beam quality from being degraded. In addition, a fiber core size mismatching between the output fiber of the master laser oscillator (which previously may have used small core size fiber to realize a fundamental mode) and an input fiber of the amplifier (which often uses large core-sized fiber to realize power amplification) may be reduced. Instead, the core size of the master laser oscillator may be increased to match the core size of the amplifier or to reduce a mismatch with respect to the core size of the amplifier.

Some implementations provide an optical fiber system that reduces a degradation of laser beam quality due to an increase in fiber core size. For example, a fundamental mode laser light (e.g., seed laser light) generated by a seed laser oscillator with a single-mode fiber may be seeded into a master laser oscillator with a larger fiber core size (e.g., into a multimode fiber). The seed laser oscillator may have a wavelength in a range of pump diode wavelengths. In other words, an output of the seed laser oscillator may be coupled to an input of the master laser oscillator. The fundamental mode laser light may be pumped into a fiber core of the master laser oscillator. Thus, the fundamental mode light may replace or supplement an input signal light of a pump signal combiner that may also be coupled into the master laser oscillator.

In some implementations, the input signal light of the pump signal combiner is derived from the fundamental mode laser light of the seed laser oscillator. Thus, the fundamental mode laser light of the seed laser oscillator may be coupled to an input of the pump signal combiner. The fundamental mode laser light output from the seed laser oscillator and coupled into the fiber core of the master laser oscillator may suppress a generation of higher-order modes in the master laser oscillator that has a multimode fiber core. Additionally, or alternatively, the fundamental mode laser light may improve the laser beam quality output from the master laser oscillator that has a multimode fiber core. The higher the power of the fundamental mode laser light, the greater the suppression of higher-order modes in the master laser oscillator. Thus, by seeding the master laser oscillator in a high-power fiber laser MOPA with the fundamental mode laser light from the seed laser oscillator, a reduction in the nonlinear effects can be realized while maintaining the laser beam quality in larger-sized core fibers.

In some implementations, a seed laser light in a fundamental mode is used to pump the master laser oscillator. The seed laser light in the fundamental mode can be generated by a seed pumping light that is pumped into the seed laser oscillator. Rare-earth element dopants inside the fiber core of the seed laser oscillator perform a stimulated emission to generate the seed laser light in the fundamental mode from the seed pumping light. In order to generate the seed laser light in the fundamental mode, the seed pumping light can be generated by coupling source light generated by a plurality of laser sources into a cladding of the fiber of the seed laser oscillator, which ultimately interacts with the fiber core of the seed laser oscillator to generate the seed laser light.

The fiber of the seed laser oscillator may be an active oscillator fiber that supports only the fundamental mode, such as a single-mode fiber or a photonic crystal fiber. A center wavelength λₚᵤₘₚ of an HR FBG and an OC FBG of the seed laser oscillator for a generation of the seed laser light may be at an emission wavelength of rare-earth element dopants in the active oscillator fiber of the seed laser oscillator, such as 976 nm for a Y_{b}³⁺ doped fiber. Additionally, a center wavelength λₗₐₛₑᵣ of an HR FBG and an OC FBG of the master laser oscillator for a generation of the primary laser light may be at an emission wavelength of rare-earth element dopants in the active oscillator fiber of the master laser oscillator. Additionally, the center wavelength λₚᵤₘₚ may be less than the center wavelength λₗₐₛₑᵣ(λₚᵤₘₚ<λ_{Laser}). In other words, the seed laser light may have a center frequency that is greater than a center frequency of the primary laser light. As a result, the seed laser light has higher energy for seeding laser light to the master laser oscillator.

A splice between an output fiber from the seed pump oscillator and an input fiber of the pump signal combiner should be configured to ensure that the seed pump light in fundamental mode is maintained in the fundamental mode inside the core of the input fiber of the pump signal combiner. This may be achieved by tapering the core size of the input fiber leading to the pump signal combiner to match the core size of the output fiber coming from the seed pump oscillator. Additionally, or alternatively, this may be achieved by bending the input fiber coupled to the pump signal combiner to remove higher-order modes. Additionally, or alternatively, this may be achieved by adding a mode field adapter between the output fiber from the seed pump oscillator and the input fiber to the pump signal combiner.

According to one example, the seed pump oscillator may output a 100 W laser signal with an oscillator output wavelength of 920 to 980 nm, the laser oscillator (e.g., the master oscillator) may output a 1000 W (1 kW) laser signal with an oscillator output wavelength of 1030 to 1090 nm, and the amplifier may output a laser signal having several kW up to 10 KW with an amplifier output wavelength of 1030 to 1090 nm.

Seed pump light and cladding pump light are both provided to the laser oscillator λ_{Laser} of the seeded MOPA oscillator. The seed pump light propagates in the fiber core, whereas the cladding pump light propagates through the cladding and the fiber core. The rare-earth element dopants inside the fiber core are stimulated by both the seed pump light and the cladding pump light. The turn-on times of the seed pump light and the cladding pump light in the laser oscillator may be controlled according to a control sequence. For example, the seed pump light may be turned on first to generate the seed laser in the fundamental mode, and then the cladding pump light may be turned on, subsequent to establishing the seed laser in the fundamental mode, in order to amplify the seed laser light. Therefore, the control sequence may be used to provide for an establishment of the fundamental mode in the seeded MOPA oscillator prior to amplifying the laser light with the cladding pump light, to reduce a risk of the cladding pump light pumping (e.g., amplifying) higher-order modes and increasing an amount of higher-order mode light.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

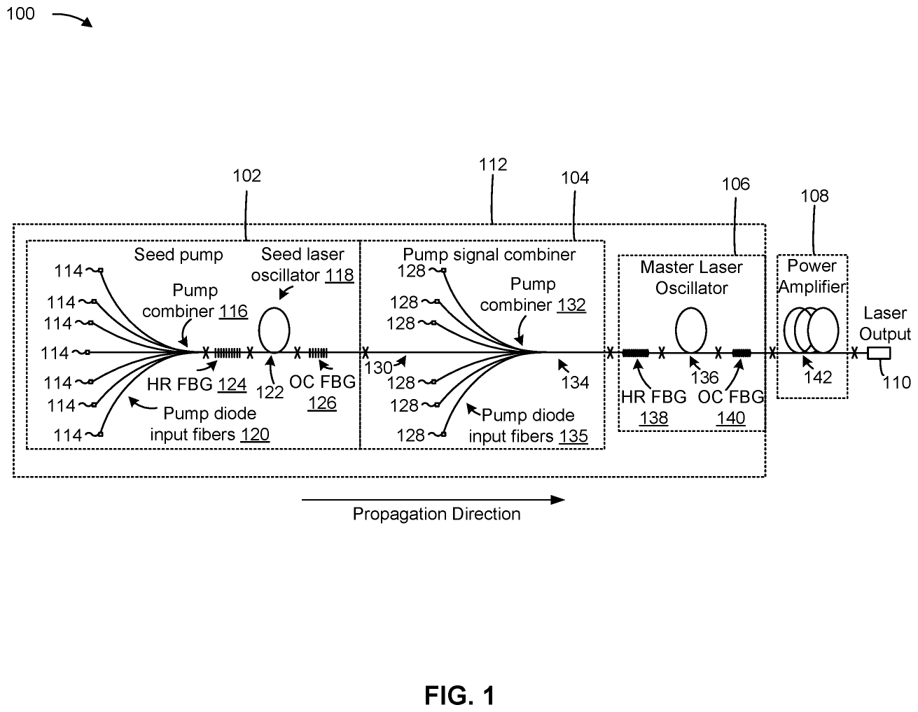

FIG. 1 shows a MOPA system 100 according to one or more implementations. The MOPA system 100 includes a seed pump 102, a pump signal combiner 104, a master laser oscillator 106, a power amplifier 108, and a laser output 110 that are coupled in series along a propagation path. The seed pump 102, pump signal combiner 104, and master laser oscillator 106 may form a seeded MOPA oscillator 112 that provides a laser beam to the power amplifier 108 for amplification. The power amplifier 108 may be configured to generate and output an amplified laser beam to the laser output 110 for output from the MOPA system 100. A splice between optical fibers (e.g., fibers) and/or between components of the MOPA system 100 may be represented by an “x.” A splice may be used to couple two fibers and/or two components together such that light is coupled into or transferred to another fiber and/or another component arranged further downstream. A component of the MOPA system 100 (e.g., the seed pump 102, the pump signal combiner 104, the master laser oscillator 106, the power amplifier 108, and the laser output 110) may include one or more fibers, with each fiber having a fiber core that is surrounded by a cladding.

The seed pump 102 may include a first plurality of laser sources 114, a first pump combiner 116, and a seed laser oscillator 118. The first plurality of laser sources 114 may be configured to generate and provide first source light to the first pump combiner 116. The first source light may be provided to the first pump combiner 116 using pump diode input fibers 120. The first pump combiner 116 may be configured to combine the first source light into a first pump light that is to be provided to the seed laser oscillator 118.

The seed laser oscillator 118 may include a first oscillator fiber 122 comprising a first fiber core and a first cladding surrounding the first fiber core. The first oscillator fiber 122 may be an active oscillator fiber with the first fiber core being doped with one or more rare-earth elements, such as erbium, ytterbium, neodymium, dysprosium, praseodymium, thulium, or holmium. Additionally, the first oscillator fiber 122 may only support light in a fundamental mode. For example, the first oscillator fiber 122 may be a single-mode fiber. The seed laser oscillator 118 also includes a first FBG 124 that is configured to operate as a first reflector (e.g., a first HR) at an input of the first fiber core and a second FBG 126 that is configured to operate as a first OC at an output of the first fiber core. The first FBG 124 and the second FBG 126 define a first laser cavity of the seed laser oscillator 118 (e.g., of the first oscillator fiber 122). The first FBG 124 and the second FBG 126 may be written into the first oscillator fiber 122. Alternatively, the first FBG 124 may be written into an input fiber of the seed laser oscillator 118 that is coupled between the first pump combiner 116 and the first oscillator fiber 122, and/or the second FBG 126 may be written into an output fiber of the seed laser oscillator 118 that is coupled between the first oscillator fiber 122 and the pump signal combiner 104.

The first FBG 124 may be used as a high reflector that reflects a high percentage of the light emitted from the first fiber core of the first oscillator fiber 122. The second FBG 126 may be configured to reflect a portion of the light emitted from the first fiber core of the first oscillator fiber 122 back toward the first FBG 124, which is subsequently reflected back by the first FBG 124 toward the second FBG 126, while allowing another portion of the light emitted from the first fiber core of the first oscillator fiber 122 to pass to the pump signal combiner 104. Thus, a portion of the light emitted from the first fiber core of the first oscillator fiber 122 may oscillate between the first FBG 124 and the second FBG 126. A first center wavelength of the first FBG 124 and the second FBG 126 corresponds to a first emission wavelength λₚᵤₘₚ of the rare-earth element dopants of the first fiber core of the first oscillator fiber 122.

The first pump combiner 116 may be configured to couple the first pump light into the first cladding of the first oscillator fiber 122, and the first cladding may be configured to guide the first pump light in the propagation direction. The first fiber core within the first laser cavity of the first oscillator fiber 122 is configured to convert the first pump light into a first seed laser light in a fundamental mode as the first pump light interacts with the first fiber core. For example, the rare-earth element dopants inside the first fiber core perform a stimulated emission by transforming the first pump light into the first seed laser light. Thus, the first seed laser light may be generated and amplified by the first fiber core within the first laser cavity of the first oscillator fiber 122. The first fiber core of the first oscillator fiber 122 is configured to guide the first seed laser light and output the first seed laser light at the output of the first fiber core of the first oscillator fiber 122. The first seed laser light may be output from the seed pump 102 and coupled into the pump signal combiner 104.

The pump signal combiner 104 may include a second plurality of laser sources 128, an input fiber 130, second pump combiner 132, and an output fiber 134. The second plurality of laser sources 128 may be configured to generate and provide second source light to the second pump combiner 132. The second source light may be provided to the second pump combiner 132 using pump diode input fibers 135.

The input fiber 130 may include a second fiber core and a second cladding surrounding the second fiber core. The second fiber core of the input fiber 130 may be coupled to the output of the first fiber core of the first oscillator fiber 122. Thus, the second fiber core of the input fiber 130 may be configured to receive and guide the first seed laser light in the fundamental mode. The input fiber 130 may be configured to provide the first seed laser light in the fundamental mode to the output fiber 134.

The second pump combiner 132 may be configured to combine the second source light into a second pump light and provide the second pump light to the output fiber 134. The output fiber 134 may include a third fiber core and a third cladding surrounding the third fiber core. The second pump combiner 132 may be configured to couple the second pump light into the third cladding of the output fiber 134, and the third cladding may be configured to guide the second pump light to the master laser oscillator 106. Additionally, the third fiber core of the output fiber 134 may receive and guide the first seed laser light in the fundamental mode in order to provide the first seed laser light in the fundamental mode to the master laser oscillator 106. Thus, the first seed laser light generated in the fundamental mode by the seed laser oscillator 118 is guided by the second fiber core and the third fiber core of the pump signal combiner 104 to be provided to the master laser oscillator 106.

The master laser oscillator 106 may include a second oscillator fiber 136 comprising a fourth fiber core and a fourth cladding surrounding the fourth fiber core. The second oscillator fiber 136 may be an active oscillator fiber with the fourth fiber core being doped with one or more rare-earth elements, such as erbium, ytterbium, neodymium, dysprosium, praseodymium, thulium, or holmium. The first fiber core of the seed laser oscillator 118 and the fourth fiber core of the master laser oscillator 106 may be doped with a same rare-earth element or doped with different rare-earth elements. Additionally, the second oscillator fiber 136 may be a multimode fiber such that the fourth fiber core is a multimode fiber core having a multimode diameter. In other words, a diameter of the fourth fiber core may be sufficiently large to support light in multiple modes. The master laser oscillator 106 also includes a third FBG 138 that is configured to operate as a second reflector (e.g., a second HR) at an input of the fourth fiber core and a fourth FBG 140 that is configured to operate as a second OC at an output of the fourth fiber core. The third FBG 138 and the fourth FBG 140 define a second laser cavity of the master laser oscillator 106 (e.g., of the second oscillator fiber 136). The third FBG 138 and the fourth FBG 140 may be written into the second oscillator fiber 136. Alternatively, the third FBG 138 may be written into an input fiber of the master laser oscillator 106 that is coupled between the output fiber 134, and the second oscillator fiber 136 and/or the fourth FBG 140 may be written into an output fiber of the master laser oscillator 106 that is coupled between the second oscillator fiber 136 and the power amplifier 108.

The third FBG 138 may be used as a high reflector that reflects a high percentage of the light emitted from the fourth fiber core of the second oscillator fiber 136. The fourth FBG 140 may be configured to reflect a portion of the light emitted from the fourth fiber core of the second oscillator fiber 136 back toward the third FBG 138, which is subsequently reflected back by the third FBG 138 toward the fourth FBG 140, while allowing another portion of the light emitted from the fourth fiber core of the second oscillator fiber 136 to pass to the power amplifier 108. Thus, a portion of the light emitted from the fourth fiber core of the second oscillator fiber 136 may oscillate between the third FBG 138 and the fourth FBG 140. A second center wavelength of the third FBG 138 and the fourth FBG 140 corresponds to a second emission wavelength λ_{Laser} of the rare-earth element dopants of the fourth fiber core of the second oscillator fiber 136.

The output fiber 134 of the pump signal combiner 104 is configured to couple the second pump light provided by the second pump combiner 132 into the fourth cladding of the second oscillator fiber 136. The fourth cladding of the second oscillator fiber 136 is configured to guide the second pump light in the propagation direction. Additionally, the fourth fiber core of the second oscillator fiber 136 within the second laser cavity is configured to receive the first seed laser light from the third fiber core of the output fiber 134 and convert the first seed laser light into a second seed laser light in the fundamental mode as the first seed laser light interacts with the fourth fiber core within the second laser cavity of the master laser oscillator 106.

For example, the rare-earth element dopants inside the fourth fiber core of the second oscillator fiber 136 perform a stimulated emission by transforming the first seed laser light in the fundamental mode into the second seed laser light in the fundamental mode. Thus, the second seed laser light may be generated and amplified by the fourth fiber core within the second laser cavity of the second oscillator fiber 136. The fourth fiber core of the second oscillator fiber 136 is configured to guide the second seed laser light and output the second seed laser light at the output of the fourth core of the second oscillator fiber 136. The second seed laser light may be output from the master laser oscillator 106 and coupled into the power amplifier 108.

In addition, the fourth fiber core of the second oscillator fiber 136 within the second laser cavity may be configured to convert the second pump light from the pump signal combiner 104 into a primary laser light in the fundamental mode as the second pump light interacts with the fourth fiber core. The rare-earth element dopants inside the fourth fiber core of the second oscillator fiber 136 perform a stimulated emission by transforming the second pump light into the primary laser light, including primary laser light in the fundamental mode. Thus, the primary laser light in the fundamental mode may be generated and amplified by the fourth fiber core within the second laser cavity of the second oscillator fiber 136. Moreover, by producing the primary laser light from the second pump light, the master laser oscillator 106 may amplify the second seed laser light with the second pump light. The fourth fiber core of the second oscillator fiber 136 is configured to guide the primary laser light in the fundamental mode and output the primary laser light in the fundamental mode at the output of the fourth core of the second oscillator fiber 136. The primary laser light in the fundamental mode may be output from the master laser oscillator 106 and coupled into the power amplifier 108.

As noted above, the third FBG 138 and the fourth FBG 140 have a second center wavelength that corresponds to a second emission wavelength λ_{Laser} of the rare-earth element dopants of the second oscillator fiber 136. In addition, the first emission wavelength λ_{Pump} may be different from the second emission wavelength λ_{Laser} such that third FBG 138 and the fourth FBG 140 are transparent to the first seed laser light in the propagation direction of the first seed laser light such that the first seed laser light does not oscillate between the third FBG 138 and the fourth FBG 140. Thus, while the second seed laser light may oscillate between the third FBG 138 and the fourth FBG 140, any remaining first seed laser light that is not absorbed by the fourth core of the second oscillator fiber 136 passes through both the third FBG 138 and the fourth FBG 140 and does not get amplified by the master laser oscillator 106. Thus, the third FBG 138 and the fourth FBG 140 form a resonator relative to the primary laser light and the second seed laser light such that portions of the primary laser light and the second seed laser light oscillate between the third FBG and the fourth FBG, but do not form a resonator relative to the first seed laser light.

The primary laser light may be generated substantially or mostly in the fundamental mode due to a presence of the second seed laser light in the fundamental mode in the fourth fiber core of the second oscillator fiber 136. For example, the first seed laser light in the fundamental mode and coupled into the fourth fiber core of the second oscillator fiber 136 is configured to maintain the primary laser light generated by the master laser oscillator 106 substantially in the fundamental mode, such that at least 80% of the primary laser light generated in the second laser cavity is in the fundamental mode. Thus, at least 80% of the primary laser light output from the second oscillator fiber 136 is in the fundamental mode, whereas less than 20% of the primary laser light output from the second oscillator fiber 136 is in a higher order mode. In other words, since the fourth fiber core is a multimode fiber core, some of the primary laser light generated in the second laser cavity is likely to be excited to a higher-order transverse mode. Thus, the second laser cavity may be configured to convert the second pump light into the primary laser light in the fundamental mode and into a primary laser light in a higher order mode. However, due to the presence of the second seed laser light in the fundamental mode in the fourth fiber core of the second oscillator fiber 136, at least 80% of a total primary laser light generated within the second laser cavity is the primary laser light in the fundamental mode, and less than 20% of the total primary laser light generated within the second laser cavity is the primary laser light in a higher-order mode.

The fourth fiber core of the second oscillator fiber 136 is configured to guide the primary laser light (e.g., the total primary laser light including the primary laser light in the fundamental mode and any primary laser light in a higher-order mode) and the second seed laser light, and output the total primary laser light and the second seed laser light at the output of the fourth fiber core. Since the primary laser light and the second seed laser light have a same center wavelength λ_{Laser} (e.g., defined by the emission wavelength λ_{Laser} of the rare-earth element dopants of the fourth fiber core of the second oscillator fiber 136), the fourth fiber core may be configured to output the primary laser light and second seed laser light as a combined laser light that is amplified by a power amplifier fiber of the power amplifier 108. In other words, since both the primary laser light and second seed laser light are generated from a stimulated emission by the rare-earth element dopants of the fourth fiber core of the second oscillator fiber 136, both the primary laser light and second seed laser light have the same center wavelength λ_{Laser} and may be indistinguishable from each other when generated simultaneously. This laser light having the primary laser light and the second seed laser light combined into indistinguishable laser light may be referred to as the combined laser light. In some implementations, the combined laser light may have an optical power of 500 watts or greater.

The power amplifier 108 may include a power amplifier fiber 142 coupled to the output of the fourth fiber core of the second oscillator fiber 136 and configured to amplify the primary laser light in the fundamental mode and the second seed laser light. For example, the power amplifier fiber 142 may amplify combined laser light output from the master laser oscillator 106. The power amplifier 108 may provide amplified laser light to the laser output 110. The power amplifier fiber 142 may have a multimode fiber core having a multimode diameter in order to realize power amplification.

Accordingly, the master laser oscillator 106 may generate both the second seed laser light in the fundamental mode and the primary laser light, which is substantially in the fundamental mode. Due to the presence of the second seed laser light in the fundamental mode in the second laser cavity of the master laser oscillator 106, the combined laser light in the master laser oscillator 106 has more light (e.g., a higher quantity or density of light) in the fundamental mode and less light (e.g., a lower quantity or density of light) in higher modes. The combined laser light generated by the master laser oscillator 106, having mostly light in the fundamental mode, may be coupled into the power amplifier 108 to be amplified. Since a higher quantity of laser light in the fundamental mode is received by the power amplifier 108, amplified light output by the power amplifier 108 also has a higher quantity of laser light in the fundamental mode. Thus, the laser output beam quality at the output of the master laser oscillator 106 and at the output of the power amplifier 108 may be improved.

For example, nonlinear effects can be reduced at the output of the master laser oscillator 106. Furthermore, the seed laser oscillator 118 allows a core size of the fiber core of the master laser oscillator 106 to be increased, which may reduce the generation of nonlinear effects, while at the same time maintain a laser output (e.g., the combined laser light) of the master laser oscillator 106 mostly in the fundamental mode (e.g., greater than 80% of the laser output is in the fundamental mode). Thus, the laser output beam quality can be maintained or improved, despite the core size of the fiber core of the master laser oscillator 106 being increased. Additionally, the seed laser oscillator 118 may enable the MOPA system 100 to produce high-power fiber lasers that have fewer higher-order transverse modes, even with larger core-sized fiber, due to the output laser light from the master laser oscillator 106 being mostly or substantially in the fundamental mode. This may help to maintain the laser output beam quality and to prevent the laser output beam quality from being degraded in a multimode fiber of the master laser oscillator 106. In addition, a fiber core size mismatching between the output fiber of the master laser oscillator 106 (which previously may have used small core size fiber to realize laser light in the fundamental mode) and an input fiber of the power amplifier 108 (which often uses large core-sized fiber to realize power amplification) may be reduced. Instead, a core size of the master laser oscillator 106 (e.g., the core size of the fourth fiber core of the second oscillator fiber 136) may be increased to match a core size of the power amplifier fiber 142 of the power amplifier 108 in order to reduce a mismatch between the core size of the second oscillator fiber 136 and the core size of the power amplifier fiber 142. Mismatches between core sizes may result in excitation of laser light into higher order modes. Thus, by reducing or eliminating the mismatch, more laser light output by the master laser oscillator 106 and the power amplifier 108 can be maintained in the fundamental mode.

In some implementations, the second fiber core of the input fiber 130 has a tapered diameter that increases in a propagation direction of the first seed laser light. For example, an input diameter of the second fiber core of the input fiber 130 may be matched with an output diameter of the first fiber core of the seed laser oscillator 118 in order to maintain the first seed laser light in the fundamental mode as the first seed laser light is coupled into the pump signal combiner 104 from the seed pump 102. Additionally, or alternatively, the input fiber 130 of the pump signal combiner 104 may have a bend section that is configured to remove higher order modes, to maintain the first seed laser light in the fundamental mode. Additionally, or alternatively, the MOPA system 100 may include a mode field adapter arranged between the second FBG 126 and the input fiber 130 of the pump signal combiner 104, to maintain the first seed laser light in the fundamental mode. Thus, the second fiber core of the input fiber 130 and the third fiber core of the output fiber 134 may be multimode fiber cores which guide the first seed laser light in the fundamental mode.

In some implementations, a turn-on sequence of the first plurality of laser sources 114 and the second plurality of laser sources 128 may be controlled such that the first plurality of laser sources 114 are turned on prior to the second plurality of laser sources 128. For example, the first plurality of laser sources 114 may be turned on for a predetermined duration prior to the second plurality of laser sources 128 such that the second seed laser light is generated in the second oscillator fiber 136 of the master laser oscillator 106 prior to turning on the second plurality of laser sources 128. In other words, the first plurality of laser sources 114 may first be turned on to generate the first pump light, which causes the first seed laser light in the fundamental mode to be generated in the first oscillator fiber 122 of the seed laser oscillator 118. The first seed laser light in the fundamental mode is then coupled into the fourth fiber core of the second oscillator fiber 136 to generate the second seed laser light in the fundamental mode in the second oscillator fiber 136. Once the second seed laser light in the fundamental mode is established in the second oscillator fiber 136, the second plurality of laser sources 128 may be turned on to produce the second pump light, which is coupled into the fourth cladding of the second oscillator fiber 136 to generate the primary laser light substantially in the fundamental mode and to amplify the second seed laser light in the fundamental mode.

By generating the second seed laser light in the fundamental mode in the second oscillator fiber 136 prior to turning on the second plurality of laser sources 128, laser light in the fundamental mode can be established within the second laser cavity of the second oscillator fiber 136 prior to pumping the second oscillator fiber 136 with the second pump light. This may lower a chance of the second pump light pumping higher order modes within the second laser cavity of the second oscillator fiber 136. Thus, by implementing the turn-on sequence, a higher laser output beam quality may be produced by the second oscillator fiber 136, with more laser light being produced in the fundamental mode.

As indicated above, FIG. 1 is provided as an example. Other examples may differ from what is described with regard to FIG. 1. The number and arrangement of devices and components shown in FIG. 1 are provided as an example. In practice, there may be additional devices or components, fewer devices or components, different devices or components, or differently arranged devices or components than those shown in FIG. 1.

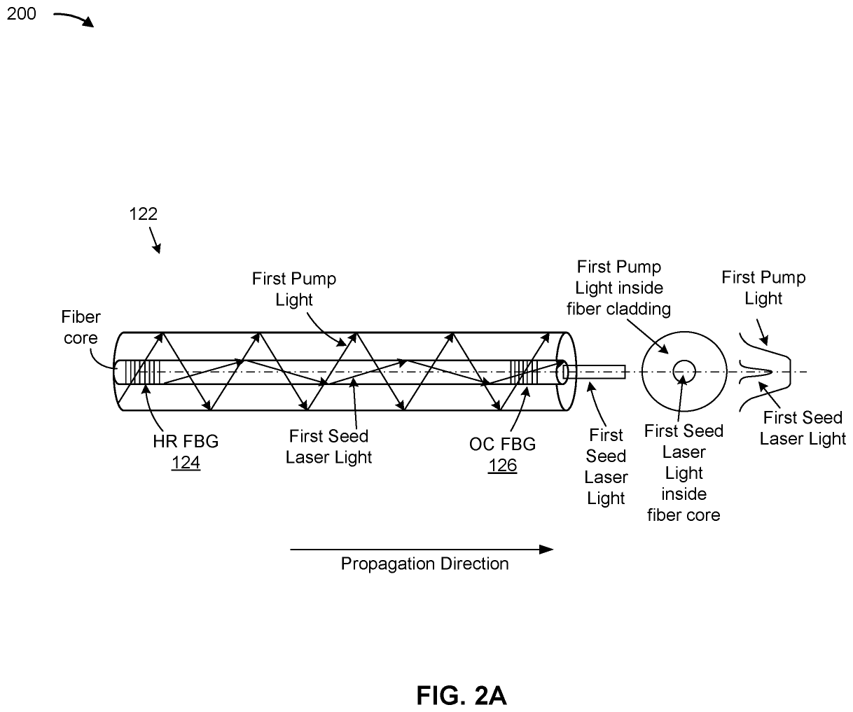

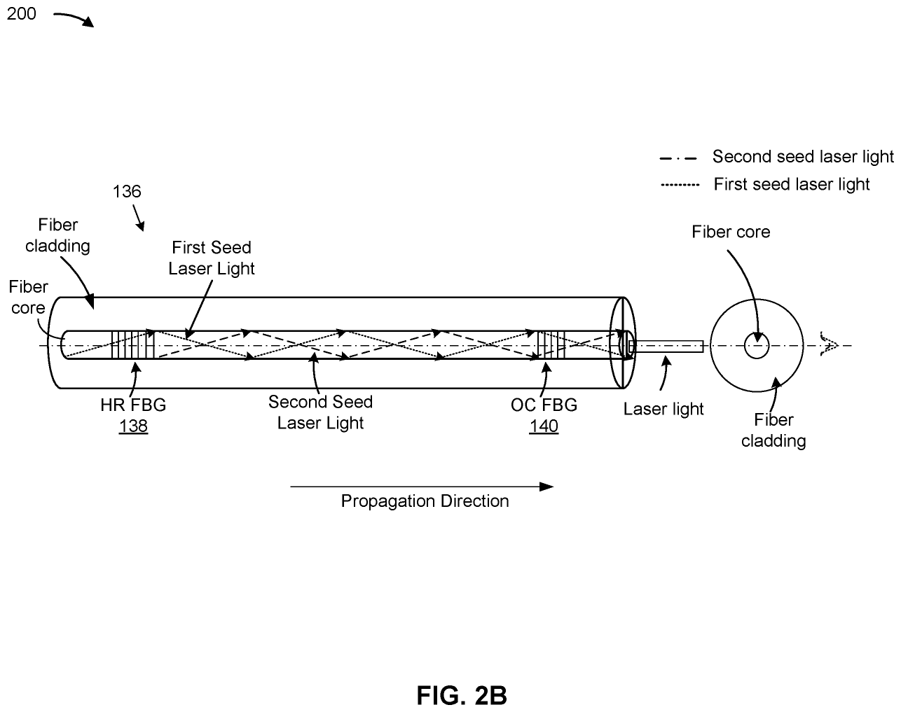

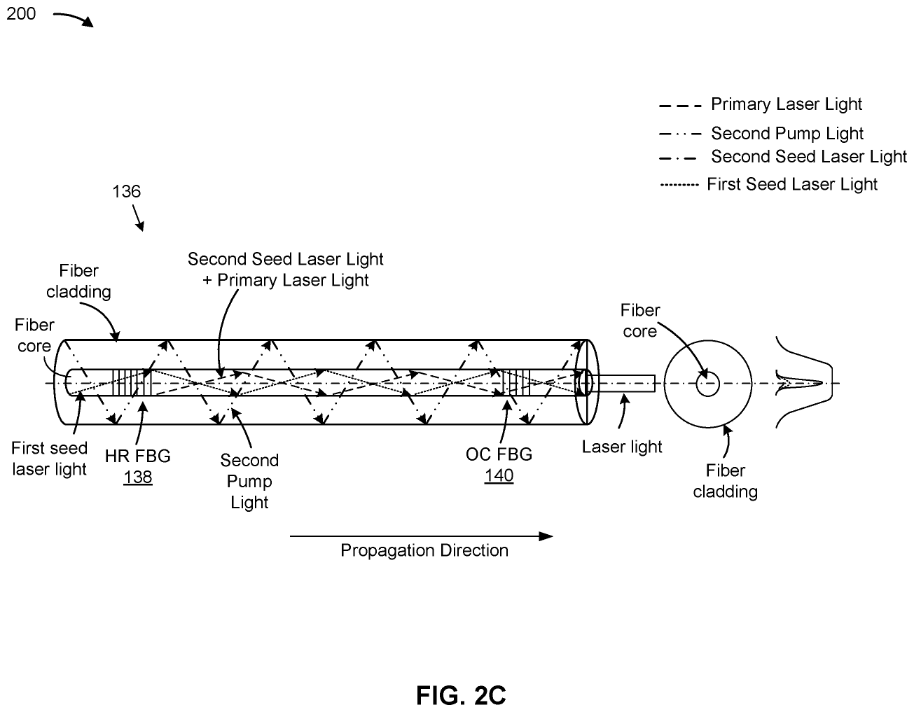

FIG. 2A shows the first oscillator fiber 122 of the seed laser oscillator 118 within the first laser cavity according to one or more implementations. The first laser cavity may be located between the first FBG 124 and the second FBG 126. The first oscillator fiber 122 may include a fiber cladding (e.g., the first cladding) that surrounds a fiber core (e.g., the first fiber core) that is doped with a rare-earth element. The fiber cladding is configured to guide the first pump light in the propagation direction. The fiber core is configured to convert the first pump light into the first seed laser light in the fundamental mode as the first pump light interacts with the fiber core. The fiber core may be a single-mode fiber core that has a fundamental mode diameter that supports light only in the fundamental mode.

As indicated above, FIG. 2A is provided as an example. Other examples may differ from what is described with regard to FIG. 2A.

FIG. 2B shows the second oscillator fiber 136 of the master laser oscillator 106 within the second laser cavity according to one or more implementations. The second laser cavity may be located between the third FBG 138 and the fourth FBG 140. The second oscillator fiber 136 may include a fiber cladding (e.g., the fourth cladding) that surrounds a fiber core (e.g., the fourth fiber core) that is doped with a rare-earth element. FIG. 2B shows the second oscillator fiber 136 during a time when the first plurality of laser sources 114 are turned on and the second plurality of laser sources 128 are turned off. As a result, the first seed laser light in the fundamental mode is produced by the seed pump 102 and is coupled into the fiber core of the second oscillator fiber 136 (e.g., via the pump signal combiner 104). The fiber core of the second oscillator fiber 136 is configured to receive the first seed laser light in the fundamental mode and convert the first seed laser light into the second seed laser light in the fundamental mode as the first seed laser light interacts with the fiber core within the second laser cavity. The fiber core may be a multimode fiber core that has a multimode diameter.

As indicated above, FIG. 2B is provided as an example. Other examples may differ from what is described with regard to FIG. 2B.

FIG. 2C shows the second oscillator fiber 136 of the master laser oscillator 106 within the second laser cavity according to one or more implementations. In particular, FIG. 2C shows the second oscillator fiber 136 during a time when the first plurality of laser sources 114 are turned on and the second plurality of laser sources 128 are turned on. The fiber core of the second oscillator fiber 136 is configured to receive the first seed laser light in the fundamental mode and convert the first seed laser light into the second seed laser light in the fundamental mode. In addition, the fiber cladding is configured to receive the second pump light and guide the second pump light in the propagation direction. As the second pump light interacts with the fiber core, the fiber core is configured to convert the second pump light into the primary laser light that is in the fundamental mode (e.g., substantially in the fundamental mode) due to a presence of the second seed laser light in the fundamental mode in the fiber core. The fiber core may be configured to output the primary laser light in the fundamental mode and second seed laser light as a combined laser light (e.g., a combined laser beam) to be amplified by the power amplifier fiber 142.

As indicated above, FIG. 2C is provided as an example. Other examples may differ from what is described with regard to FIG. 2C.

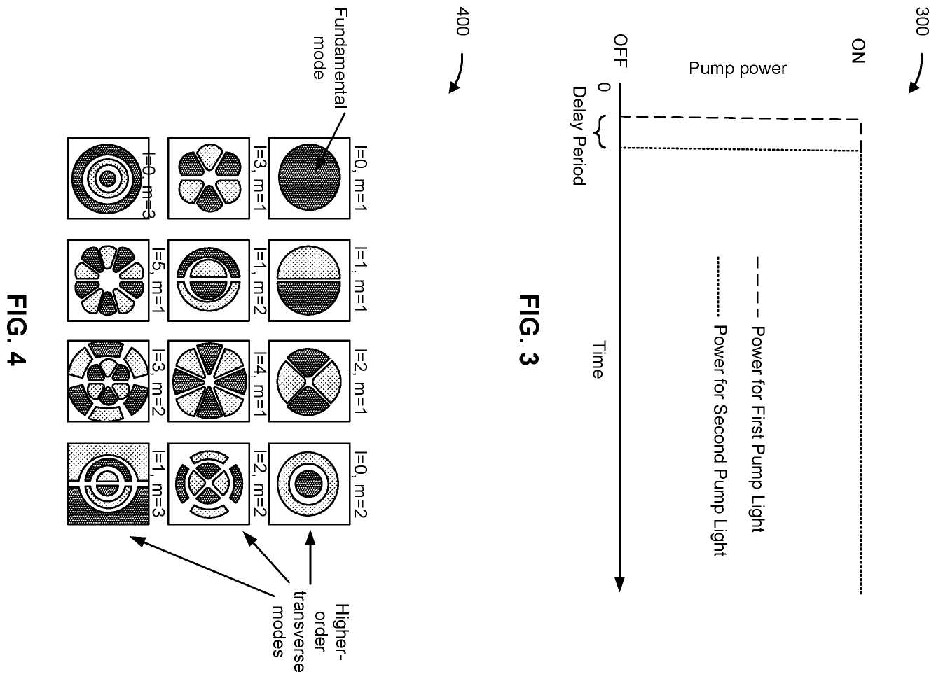

FIG. 3 shows a timing diagram 300 for pump light turn on according to one or more implementations. During a turn-on sequence, the first plurality of laser sources 114 and the second plurality of laser sources 128 may be controlled such that the first plurality of laser sources 114 (e.g., power for the first pump light) are turned on prior to the second plurality of laser sources 128 (e.g., power for the second pump light). The second plurality of laser sources 128 may be turned on after a predetermined delay period after the first plurality of laser sources 114 have been turned on such that the second seed laser light can be established in the second oscillator fiber 136 before the second oscillator fiber 136 is pumped with the second pump light.

By generating the second seed laser light in the fundamental mode in the second oscillator fiber 136 prior to turning on the second plurality of laser sources 128, laser light in the fundamental mode can be established within the second laser cavity of the second oscillator fiber 136 prior to pumping the second oscillator fiber 136 with the second pump light. This may lower a chance of the second pump light pumping higher order modes within the second laser cavity of the second oscillator fiber 136. Thus, by implementing the turn-on sequence, a higher laser output beam quality may be produced by the second oscillator fiber 136, with more laser light being produced in the fundamental mode.

As indicated above, FIG. 3 is provided as an example. Other examples may differ from what is described with regard to FIG. 3.

FIG. 4 shows a diagram 400 illustrating different laser modes, including the fundamental mode. All other laser modes are referred to as higher-order transverse modes, or simply higher-order modes. A laser beam has a higher beam quality when the laser beam is in the fundamental mode. Thus, the more laser light in the fundamental mode that is produced by the second oscillator fiber 136, the higher the laser output beam quality will be.

As indicated above, FIG. 4 is provided as an example. Other examples may differ from what is described with regard to FIG. 4.

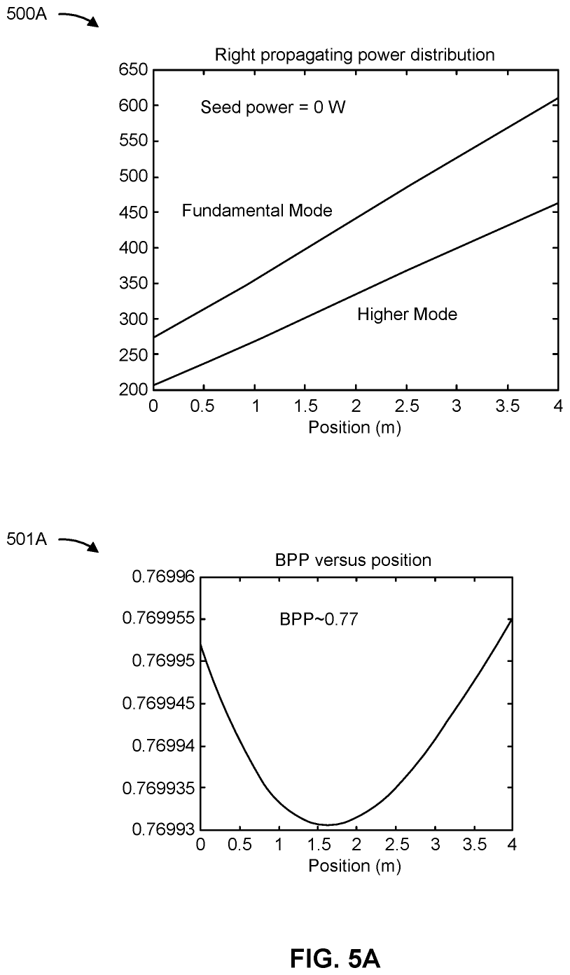

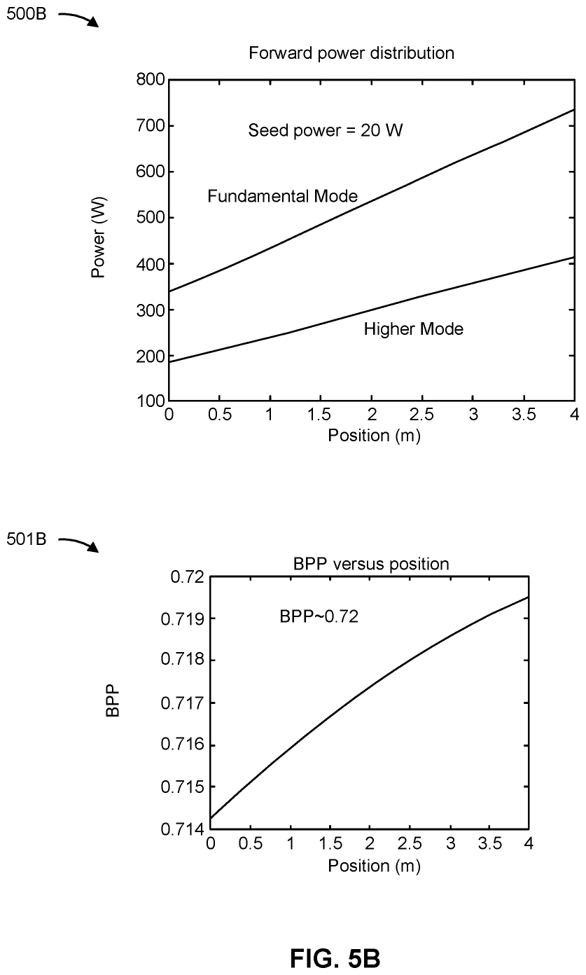

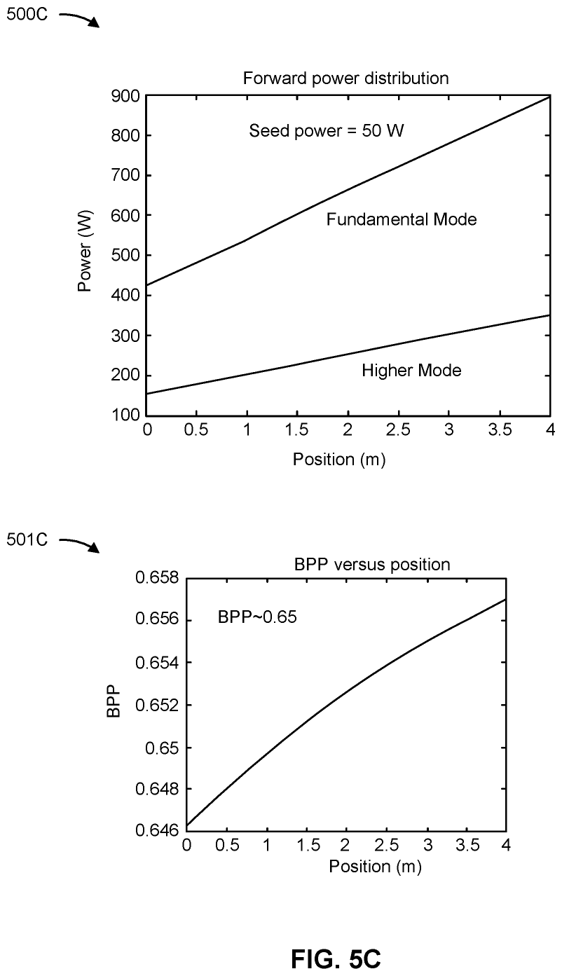

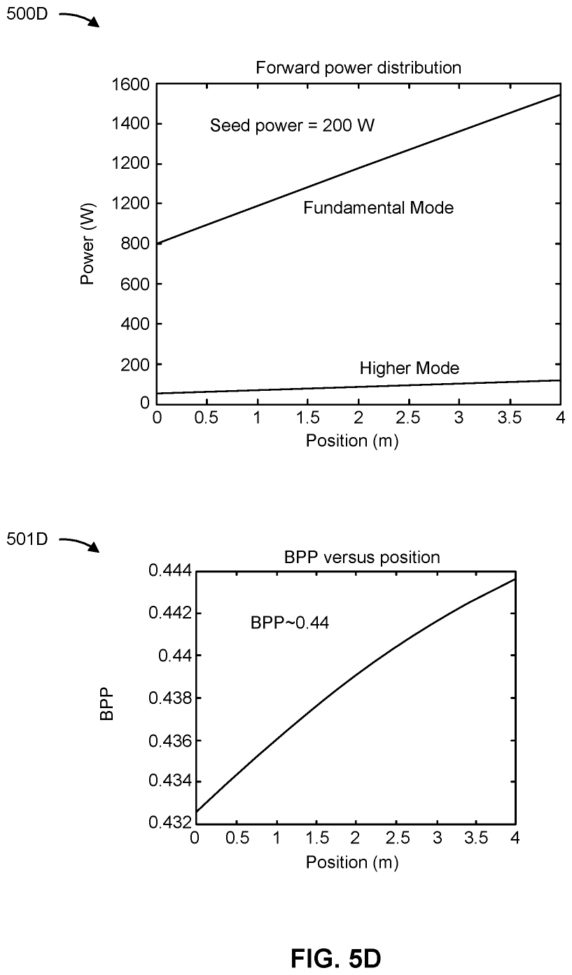

FIGS. 5A-5D show various diagrams related to a laser output beam quality of a master laser oscillator according to one or more implementations. In particular, FIGS. 5A-5D show various diagrams of the laser output beam quality related to the optical power (e.g., seed power) of the first seed laser light being seeded into the fiber core of the second oscillator fiber 136 of the master laser oscillator 106.

FIG. 5A shows a power distribution diagram 500A and a beam parameter product (BPP) diagram 501A when the first seed laser light has an optical power of 0 W (e.g., the first seed laser light is not present). The power distribution diagram 500A shows a power of fundamental laser light (e.g., the combined laser light in the fundamental mode) relative to a position (in meters) within the second oscillator fiber 136, and a power of higher-mode laser light (e.g., the combined laser light in the higher-order mode) relative to the position (in meters) of the laser light within the second oscillator fiber 136, as the laser light propagates through the second oscillator fiber 136. The BPP diagram 501A shows the BPP of the total laser light (e.g., the combined laser light) within the second oscillator fiber 136 relative to the position (in meters) of the total laser light within the second oscillator fiber 136, as the laser light propagates through the second oscillator fiber 136. The BPP of a laser beam is defined as the product of beam radius (measured at the beam waist) and the beam divergence half-angle (measured in the far field). The typical units of BPP are mm mrad (millimeters times milliradians). The BPP is often used to specify the beam quality of a laser beam: the higher the beam parameter product, the lower the beam quality. The BPP in the BPP diagram 501A reaches about 0.77.

FIG. 5B shows a power distribution diagram 500B and a BPP diagram 501B when the first seed laser light has an optical power of 20 W. The power distribution diagram 500B shows a power of fundamental laser light (e.g., the combined laser light in the fundamental mode) relative to a position (in meters) within the second oscillator fiber 136, and a power of higher-mode laser light (e.g., the combined laser light in the higher-order mode) relative to the position (in meters) of the laser light within the second oscillator fiber 136, as the laser light propagates through the second oscillator fiber 136. The power of fundamental laser light in the power distribution diagram 500B has shifted higher relative to the power of fundamental laser light shown in the power distribution diagram 500A. In addition, the power of higher-mode laser light in the power distribution diagram 500B has shifted lower relative to the power of higher-mode laser light shown in the power distribution diagram 500A.

The BPP diagram 501B shows the BPP of the total laser light (e.g., the combined laser light) within the second oscillator fiber 136 relative to the position (in meters) of the total laser light within the second oscillator fiber 136, as the laser light propagates through the second oscillator fiber 136. The BPP in the BPP diagram 501B reaches about 0.72, which is an improvement over the BPP of 0.77 in the BPP diagram 501A.

FIG. 5C shows a power distribution diagram 500C and a BPP diagram 501C when the first seed laser light has an optical power of 50 W. The power distribution diagram 500C shows a power of fundamental laser light (e.g., the combined laser light in the fundamental mode) relative to a position (in meters) within the second oscillator fiber 136, and a power of higher-mode laser light (e.g., the combined laser light in the higher-order mode) relative to the position (in meters) of the laser light within the second oscillator fiber 136, as the laser light propagates through the second oscillator fiber 136. The power of fundamental laser light in the power distribution diagram 500C has shifted higher relative to the power of fundamental laser light shown in the power distribution diagram 500B. In addition, the power of higher-mode laser light in the power distribution diagram 500C has shifted lower relative to the power of higher-mode laser light shown in the power distribution diagram 500B.

The BPP diagram 501C shows the BPP of the total laser light (e.g., the combined laser light) within the second oscillator fiber 136 relative to the position (in meters) of the total laser light within the second oscillator fiber 136, as the laser light propagates through the second oscillator fiber 136. The BPP in the BPP diagram 501C reaches about 0.65, which is an improvement over the BPP of 0.72 in the BPP diagram 501B.

FIG. 5D shows a power distribution diagram 500D and a BPP diagram 501D when the first seed laser light has an optical power of 200 W. The power distribution diagram 500D shows a power of fundamental laser light (e.g., the combined laser light in the fundamental mode) relative to a position (in meters) within the second oscillator fiber 136, and a power of higher-mode laser light (e.g., the combined laser light in the higher-order mode) relative to the position (in meters) of the laser light within the second oscillator fiber 136, as the laser light propagates through the second oscillator fiber 136. The power of fundamental laser light in the power distribution diagram 500D has shifted higher relative to the power of fundamental laser light shown in the power distribution diagram 500C. In addition, the power of higher-mode laser light in the power distribution diagram 500D has shifted lower relative to the power of higher-mode laser light shown in the power distribution diagram 500C.

The BPP diagram 501D shows the BPP of the total laser light (e.g., the combined laser light) within the second oscillator fiber 136 relative to the position (in meters) of the total laser light within the second oscillator fiber 136, as the laser light propagates through the second oscillator fiber 136. The BPP in the BPP diagram 501D reaches about 0.44, which is an improvement over the BPP of 0.65 in the BPP diagram 501C.

Thus, the amount of higher-mode laser light decreases as the power of the first seed laser light is increased. For example, the amount of higher-mode laser light shown in FIG. 5A is relatively higher compared to the amount of higher-mode laser light shown in FIG. 5D. Moreover, the BPP decreases and the beam quality improves as the power of the first seed laser light is increased. Thus, the first seed laser light in fundamental mode can suppress the generation of higher-order modes in the master laser oscillator 106 that has a larger core-sized fiber (e.g., a multimode fiber core). Additionally, the first seed laser light in fundamental mode can improve the laser beam quality output from master laser oscillator 106 that has a larger core-sized fiber (e.g., a multimode fiber core).

As indicated above, FIGS. 5A-5D are provided as examples. Other examples may differ from what is described with regard to FIGS. 5A-5D.

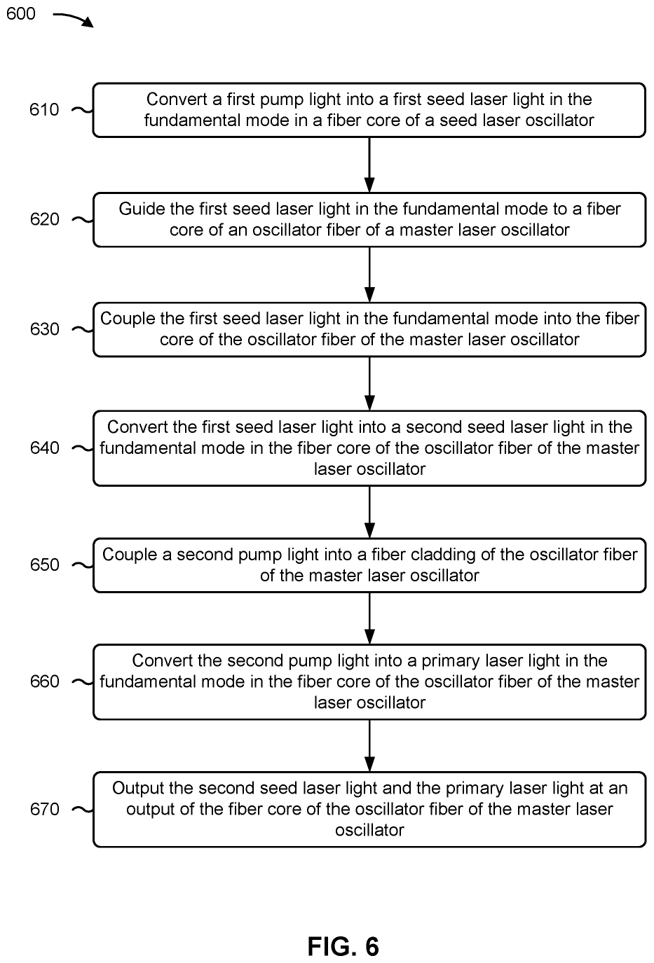

FIG. 6 is a flowchart of an example process 600 associated with a MOPA amplifier with a seeded oscillator for fiber laser generation. In some implementations, one or more process blocks of FIG. 6 are performed by a MOPA system (e.g., MOPA system 100). Additionally, or alternatively, one or more process blocks of FIG. 6 may be performed by one or more components of the MOPA system 100, such as the seed pump 102, the pump signal combiner 104, the master laser oscillator 106, the power amplifier 108, and the laser output 110.

As shown in FIG. 6, process 600 may include converting a first pump light into a first seed laser light in the fundamental mode as the first pump light interacts with a fiber core within a first laser cavity of a seed laser oscillator (block 610). For example, the seed pump 102 may convert the first pump light into the first seed laser light in the fundamental mode in the fiber core of the seed laser oscillator 118, as described above.

As further shown in FIG. 6, process 600 may include guiding the first seed laser light in the fundamental mode to a fiber core of an oscillator fiber of a master laser oscillator (block 620). For example, the pump signal combiner 104 may guide the first seed laser light in the fundamental mode to a fiber core of the second oscillator fiber 136 of the master laser oscillator 106, as described above.

As further shown in FIG. 6, process 600 may include coupling the first seed laser light in the fundamental mode into the fiber core of the oscillator fiber of the master laser oscillator (block 630). For example, the output fiber 134 may couple the first seed laser light in the fundamental mode to the fiber core of the second oscillator fiber 136 of the master laser oscillator 106, as described above.

As further shown in FIG. 6, process 600 may include converting the first seed laser light into a second seed laser light in the fundamental mode in the fiber core of the oscillator fiber of the master laser oscillator (block 640). For example, the second oscillator fiber 136 may convert the first seed laser light into the second seed laser light in the fundamental mode as the first seed laser light interacts with the fiber core within a second laser cavity of the second oscillator fiber 136, as described above.

As further shown in FIG. 6, process 600 may include coupling a second pump light into a fiber cladding of the oscillator fiber of the master laser oscillator (block 650). For example, the pump signal combiner 104 may couple the second pump light into the fiber cladding of the second oscillator fiber 136 of the master laser oscillator 106, as described above.

As further shown in FIG. 6, process 600 may include converting the second pump light into a primary laser light in the fundamental mode in the fiber core of the oscillator fiber of the master laser oscillator (block 660). For example, the second oscillator fiber 136 may convert the second pump light into the primary laser light in the fundamental mode as the second pump light interacts with the fiber core within a second laser cavity of the second oscillator fiber 136 due to a presence of the second seed laser light in the fundamental mode in the fiber core of the second oscillator fiber 136, as described above.

As further shown in FIG. 6, process 600 may include outputting the second seed laser light and the primary laser light at an output of the fiber core of the oscillator fiber of the master laser oscillator (block 670). For example, the second oscillator fiber 136 may output the second seed laser light and the primary laser light, both in the fundamental mode, as combined laser light, as described above.

Process 600 may include additional implementations, such as any single implementation or any combination of implementations described below and/or in connection with one or more other processes described elsewhere herein.

In an implementation, the second seed laser light in the fundamental mode may be established in the second laser cavity of the oscillator fiber prior to coupling the second pump light into the fiber cladding of the oscillator fiber.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A master oscillator power amplifier (MOPA) system, comprising:
a seed pump comprising:
a first plurality of laser sources configured to provide first source light;
a first pump combiner configured to combine the first source light into a first pump light; and
a seed laser oscillator comprising:
a first oscillator fiber comprising a first fiber core and a first cladding surrounding the first fiber core;
a first fiber Bragg grating (FBG) that is configured to operate as a first reflector at an input of the first fiber core; and
a second FBG that is configured to operate as a first output coupler (OC) at an output of the first fiber core, wherein the first FBG and the second FBG define a first laser cavity of the first oscillator fiber,
wherein the first pump combiner is configured to couple the first pump light into the first cladding,
wherein the first cladding is configured to guide the first pump light,
wherein the first fiber core within the first laser cavity is configured to convert the first pump light into a first seed laser light in a fundamental mode as the first pump light interacts with the first fiber core, and
wherein the first fiber core is configured to guide the first seed laser light and output the first seed laser light at the output of the first fiber core;
a pump signal combiner comprising:
an input fiber comprising a second fiber core and a second cladding surrounding the second fiber core, wherein the second fiber core is coupled to the output of the first fiber core, and wherein the second fiber core is configured to receive and guide the first seed laser light in the fundamental mode;
a second plurality of laser sources configured to provide second source light;
a second pump combiner configured to combine the second source light into a second pump light; and
an output fiber comprising a third fiber core and a third cladding surrounding the third fiber core, wherein the second pump combiner is configured to couple the second pump light into the third cladding, wherein the third cladding is configured to guide the second pump light, and wherein the third fiber core is configured to receive and guide the first seed laser light in the fundamental mode;
a laser oscillator comprising:
a second oscillator fiber comprising a fourth fiber core and a fourth cladding surrounding the fourth fiber core;
a third FBG that is configured to operate as a second reflector at an input of the fourth fiber core; and
a fourth FBG that is configured to operate as a second OC at an output of the fourth fiber core, wherein the third FBG and the fourth FBG define a second laser cavity of the second oscillator fiber,
wherein the output fiber is configured to couple the second pump light into the fourth cladding,
wherein the fourth cladding is configured to guide the second pump light,
wherein the fourth fiber core within the second laser cavity is configured to receive the first seed laser light from the third fiber core and convert the first seed laser light into a second seed laser light in the fundamental mode as the first seed laser light interacts with the fourth fiber core within the second laser cavity,
wherein the fourth fiber core within the second laser cavity is configured to convert the second pump light into a primary laser light in the fundamental mode as the second pump light interacts with the fourth fiber core due to a presence of the second seed laser light in the fundamental mode in the fourth fiber core, and
wherein the fourth fiber core is configured to guide the primary laser light in the fundamental mode and the second seed laser light in the fundamental mode and output the primary laser light in the fundamental mode and the second seed laser light in the fundamental mode at the output of the fourth fiber core; and
a power amplifier fiber coupled to the output of the fourth fiber core and configured to amplify the primary laser light in the fundamental mode and the second seed laser light in the fundamental mode.

2. The MOPA system of claim 1, wherein the fourth fiber core is configured to output the primary laser light in the fundamental mode and second seed laser light in the fundamental mode as a combined laser light that is amplified by the power amplifier fiber.

3. The MOPA system of claim 2, wherein the combined laser light has an optical power of 500 watts or greater.

4. The MOPA system of claim 1, wherein the laser oscillator is configured to amplify the second seed laser light in the fundamental mode with the second pump light.

5. The MOPA system of claim 1, wherein the first fiber core is a single-mode fiber core having a fundamental mode diameter that supports light only in the fundamental mode.

6. The MOPA system of claim 1, wherein the fourth fiber core is a multimode fiber core having a multimode diameter.

7. The MOPA system of claim 1, wherein the first seed laser light has a first center wavelength, and
wherein the primary laser light has a second center wavelength that is greater than the first center wavelength.

8. The MOPA system of claim 1, wherein the second seed laser light in the fundamental mode has a first center wavelength, and
wherein the primary laser light has a second center wavelength that is the same as the first center wavelength.

9. The MOPA system of claim 1, wherein the first fiber core is doped with a first rare-earth element and the fourth fiber core is doped with the first rare-earth element or a second rare-earth element.

10. The MOPA system of claim 9, wherein a first center wavelength of the first FBG and the second FBG corresponds to a first emission wavelength of the first rare-earth element, and
wherein a second center wavelength of the third FBG and the fourth FBG corresponds to a second emission wavelength of the first rare-earth element or the second rare-earth element.

11. The MOPA system of claim 10, wherein the third FBG and the fourth FBG are transparent to the first seed laser light in a propagation direction of the first seed laser light such that the first seed laser light does not oscillate between the third FBG and the fourth FBG, the propagation direction being defined by a direction from the pump signal combiner toward the power amplifier fiber, and
wherein the third FBG and the fourth FBG form a resonator relative to the primary laser light and the second seed laser light in the fundamental mode such that portions of the primary laser light and the second seed laser light in the fundamental mode oscillate between the third FBG and the fourth FBG.

12. The MOPA system of claim 10, wherein the first rare-earth element is erbium, ytterbium, neodymium, dysprosium, praseodymium, thulium, or holmium, and
wherein the second rare-earth element is erbium, ytterbium, neodymium, dysprosium, praseodymium, thulium, or holmium.

13. The MOPA system of claim 1, wherein the first seed laser light is configured to maintain the second seed laser light generated by the laser oscillator in the fundamental mode.

14. The MOPA system of claim 13, wherein the first seed laser light is configured to maintain the primary laser light generated by the laser oscillator substantially in the fundamental mode such that at least 80% of the primary laser light generated in the second laser cavity is in the fundamental mode.

15. The MOPA system of claim 1, wherein the first plurality of laser sources are configured to be activated prior to the second plurality of laser sources such that the second seed laser light in the fundamental mode is present in the fourth fiber core of the second oscillator fiber prior to the second pump light being present in the fourth cladding of the second oscillator fiber.

16. The MOPA system of claim 1, wherein the second fiber core of the input fiber has a tapered diameter that increases in a propagation direction of the first seed laser light, wherein an input diameter of the second fiber core is matched with an output diameter of the first fiber core, to maintain the first seed laser light in the fundamental mode,
wherein the input fiber has a bend section that is configured to remove higher order modes, to maintain the first seed laser light in the fundamental mode, or
the MOPA system further includes a mode field adapter arranged between the second FBG and the input fiber of the pump signal combiner, to maintain the first seed laser light in the fundamental mode.

17. The MOPA system of claim 1, wherein the fourth fiber core within the second laser cavity is configured to convert the second pump light into the primary laser light in the fundamental mode and into a primary laser light in a higher order mode, wherein at least 80% of a total primary laser light generated within the second laser cavity is the primary laser light in the fundamental mode and less than 20% of the total primary laser light generated within the second laser cavity is the primary laser light in the higher order mode due to the presence of the second seed laser light in the fundamental mode in the fourth fiber core.

18. A master oscillator power amplifier (MOPA) system, comprising:
a seed laser oscillator comprising a first laser cavity configured to receive a first pump light and convert the first pump light into a first seed laser light in a fundamental mode as the first pump light interacts with a first fiber core of the seed laser oscillator, wherein the first fiber core is configured to guide the first seed laser light and output the first seed laser light at an output of the first fiber core;
a pump signal combiner comprising:
an input fiber comprising a second fiber core and an input fiber cladding surrounding the second fiber core, wherein the second fiber core is configured to receive and guide the first seed laser light in the fundamental mode; and
an output fiber comprising a third fiber core and an output fiber cladding surrounding the third fiber core, wherein the output fiber is configured to receive a second pump light, wherein the second pump light is coupled into the output fiber cladding, wherein the output fiber cladding is configured to guide the second pump light, and wherein the third fiber core is configured to receive and guide the first seed laser light in the fundamental mode; and
a primary laser oscillator comprising:
an oscillator fiber comprising a fourth fiber core, an oscillator fiber cladding surrounding the fourth fiber core, and a second laser cavity,
wherein the output fiber is configured to couple the second pump light into the oscillator fiber cladding,
wherein the oscillator fiber cladding is configured to guide the second pump light,
wherein the fourth fiber core within the second laser cavity is configured to receive the first seed laser light from the third fiber core and convert the first seed laser light into a second seed laser light in the fundamental mode as the first seed laser light interacts with the fourth fiber core,
wherein the fourth fiber core within the second laser cavity is configured to convert the second pump light into a primary laser light in the fundamental mode as the second pump light interacts with the fourth fiber core due to a presence of the second seed laser light in the fundamental mode in the fourth fiber core, and
wherein the fourth fiber core is configured to guide the second seed laser light and the primary laser light and output the second seed laser light and the primary laser light at an output of the fourth fiber core.

19. The MOPA system of claim 18, wherein the first seed laser light is configured to maintain the primary laser light generated by the primary laser oscillator substantially in the fundamental mode such that at least 80% of the primary laser light generated in the second laser cavity is in the fundamental mode. 20 A method of generating primary laser light in a fundamental mode, the method comprising:
converting a first pump light into a first seed laser light in the fundamental mode as the first pump light interacts with a first fiber core within a first laser cavity of a seed laser oscillator;
guiding the first seed laser light in the fundamental mode through a second fiber core of an input fiber of a pump signal combiner that is configured to receive the first seed laser light in the fundamental mode from the first fiber core;
coupling second pump light into an output fiber cladding of an output fiber of the pump signal combiner that is configured to guide the second pump light;
guiding the first seed laser light in the fundamental mode through a third fiber core of the output fiber that is configured to receive the first seed laser light in the fundamental mode from the second fiber core;
coupling the second pump light from the output fiber into an oscillator fiber cladding of an oscillator fiber;
coupling the first seed laser light in the fundamental mode from the output fiber into a fourth fiber core of the oscillator fiber;
converting the first seed laser light into a second seed laser light in the fundamental mode as the first seed laser light interacts with the fourth fiber core within a second laser cavity of the oscillator fiber;
converting the second pump light into the primary laser light in the fundamental mode as the second pump light interacts with the fourth fiber core within a second laser cavity of the oscillator fiber due to a presence of the second seed laser light in the fundamental mode in the fourth fiber core; and
outputting the second seed laser light and the primary laser light at an output of the fourth fiber core.

21. The method of claim 20, wherein the second seed laser light in the fundamental mode is established in the second laser cavity of the oscillator fiber prior to coupling the second pump light into the oscillator fiber cladding of the oscillator fiber.
